(19) United States
(12) Patent Application Publication
(10) Pub. No.: US 2026/0211956 A1
(43) Pub. Date: Jul. 23, 2026

(54) Method for managing the search for documents

(71) Applicant: ORANGE, Issy-les-Moulineaux (FR)

(72) Inventors: Ghislain MONCOMBLE, CHATILLON CEDEX (FR); Johannes HEINECKE, CHATILLON CEDEX (FR)

(21) Appl. No.: 19/454,914

(22) Filed: Jan. 21, 2026

(30) Foreign Application Priority Data
Jan. 22, 2025 (FR) FR2500656

(51) Int. Cl. G06F 16/93

(52) U.S. Cl. CPC G06F 16/93

(57) ABSTRACT

A method for managing a search for documents among a set of documents, the documents being indexed. The method includes obtaining a second list of documents from a first list of documents by taking into account a concept present in a document of the first list. The documents of the first list result from an index search among the set of documents.

### CROSS REFERENCE TO RELATED APPLICATIONS

This application claims priority to French Patent Application No. FR2500656, filed January 22, 2025, the entire contents of which are incorporated herein by reference.

### TECHNICAL FIELD

The technical field is that of the search for information.

More precisely, the present disclosure relates to a method for managing the search for documents among a set of documents. The search for documents in question is for example performed on the Internet, or indeed among a predefined set of documents such as a set of classified advertisements or news agency reports or any other set of documents.

### PRIOR ART

From the 90s, the emergence of the Internet and the Web was accompanied by the appearance of search engines allowing users to find documents among the multitudes of documents present on the Web. The first search engines (Altavista, Lycos etc.) were of the "nomenclature" type, i.e. each document present in the search engine was linked to a hierarchical list of topics. By scrolling through the lists, and by refining the subject sought, the user was eventually able to find the documents for which they were looking.

This approach has become unusable given the exponential explosion in the number of documents accessible on the Internet. However, it remains popular in specific areas. For example, classified advertising sites may organize the search of their database of classified advertisements in this way. However, almost all current search engines operate on the principle of indexing the content of documents with software robots and comparing the obtained indexes with search terms provided by the user, with a view to suggesting the documents that are most relevant according to a ranking algorithm. The ranking algorithms may take into account other considerations, such as the number of documents pointing to a given document. A more popular document will be suggested more than another.

Algorithms for searching for documents through keyword indexation, whether on the Web or in restricted sets of documents, are well known and have certain advantages. Nevertheless, mention may be made of the following shortcomings of current techniques:

Ranking by score does not necessarily mean that the most relevant document will be suggested. Specifically, as mentioned above, the ranking algorithm may use information such as the popularity of the site on which the document is found when ranking a document. A document that is more able than another to provide an answer to a given search query may be ranked lower because of its lower visibility.

A second shortcoming of existing algorithms is they suggest many duplicates. Specifically, modern publishing techniques encourage publishers to publish almost identical documents many times in order to increase their visibility. Search engines have difficulty differentiating between these duplicates and will display users documents that are very similar, and which do not provide useful information.

A third defect of existing algorithms is that they do not take into account the notions or topics underlying the terms of the search query. These algorithms will therefore discard the results of documents conveying similar information expressed in different terms to those of the user's search. This problem is exacerbated by the presence of many duplicates that will take the place of different documents, dealing with the same topic. In other words, the presence of many duplicates hides from the user relevant documents that are given a lower rank by the search algorithm.

These drawbacks are compounded by the publishing strategies followed by some content publishers. Publishers publish a large number of identical documents, something which is inexpensive to do in terms of writing cost, then seek through presentational tricks to deceive search engines seeking to limit duplicates. In this way, these publishers achieve a high visibility at a lower cost.

One or more aspects of the present disclosure aim to improve the situation.

### SUMMARY

According to a first functional aspect, the present disclosure relates to a method for managing the search for documents among a set of documents, the documents being indexed, the method comprising:

obtaining a second list of documents from a first list of documents by taking into account a concept present in a document of the first list, the documents of the first list resulting from an index search among the set of documents.

Thanks to an aspect of the present disclosure, the results of a conventional document search following an index search query are improved using the concepts present in the documents. The concepts present in the documents correspond to the topics covered by the documents. The discovery of the concepts present in the documents is the result of a search using semantic analysis techniques. The use of the concepts present in the documents makes it possible to carry out a search that does not stop at the syntactic aspects of the documents but also takes into account their semantic aspects. In particular, documents that use different terms but that cover identical topics will thus be considered alike, this making it possible to address the aforementioned shortcomings of the search algorithms of the prior art:

The most semantically relevant document will be able to be suggested. In particular, documents containing in the most complete way all the various concepts related to a topic may be suggested.

The method allows duplicates to be avoided since, given different documents containing identical concepts, only one may be kept.

The method makes it possible to find various documents dealing with the same topic even when they use different terms to do so since the search for concepts present in the documents makes it possible to focus on these same topics.

The search for documents according to an aspect of the present disclosure is for example made on the Web but may also be made in a set of documents that is limited but that remains large, for example documents of one or more classified advertising sites or indeed a set of news articles or news agency reports drawn from one or more news sites.

According to one embodiment, which may be implemented alternatively to or cumulatively with this functional aspect, the obtainment of the second list of documents depends on data representative of concepts present in the documents of the first list.

Concepts present in the documents are discovered using various semantic analysis techniques. The data representative of the concepts present in the documents may be of a plurality of different types.

A first example of data representative of concepts are classifications or classification elements. A classification is a set of terms, grouped in a hierarchical way, that allow the various possible items of a field to be exhaustively described. For example, various economic activities are described by the European Union in a classification denoted NACE, an acronym of Nomenc/ature statistique des Activites economiques dans /a Communaute Europienne. In another example, the Dewey Decimal Classification (DDC) is a system aiming to classifying the holdings of a library in their entirety.

The documents of classified advertising sites or of the sites of news agencies are naturally organized according to classifications, for example indicating the categories of items sold or the topics of news reports. These initial classifications may be supplemented by semantic analyses of the text of the documents. For example, a news report classified as having the "economy" as its subject may be analyzed to see that the topic of the report is more precisely the presentation of financial results, for a particular company, for a particular year and with complementary characteristics of increasing detail.

Another example of data representative of concepts are instances of concepts expressed in a semantic representation language. Such a language is for example AMR, abbreviation of Abstract Meaning Representation. Another semantic representation language is OWL, acronym of Web Ontology Language, which is standardized by the W3C (World Wide Web Consortium). Textual analysis tools may produce, from documents, instances of concepts present in the documents as represented in these various languages.

Another example of data representative of concepts are embeddings, which may be obtained by analyzing documents (texts or images) using generative artificial-intelligence techniques. Embeddings are vectors of real numbers that implicitly represent semantic concepts, for example derived from the learning of artificial neural networks subjected to training. Embeddings may be obtained for relatively large parts of documents and for documents of a textual or pictorial nature.

In order to further delve into the example of classifications, which are not however the only example of data representative of concepts that may be used, when the documents in question are classified advertisements, the classification will indicate hierarchically whether the advertisement consists of an offer to buy, sell, or rent and if the item sought or offered is a piece of real estate or movable property and, if it is a question of a piece of real estate, whether it is a house or an apartment etc. Additional characteristics such as price, location, etc. are also present in additional classifications.

In another example, when the documents are news agency reports, the classifications associated with the source of the information will indicate, for example, whether the reports cover political or economic or other matters; the geographical location of the topic covered; the people in question; the company in question; the financial data in question etc. Here again, it should be readily understood that a plurality of classifications may be associated with the same document.

To obtain the concepts present in the documents, which correspond to the topics covered by the documents, artificial-intelligence document-analysis techniques may be used. These semantic analysis techniques are able to extract the topics covered by a document by taking into account the keywords present in the documents, their synonyms, and by carrying out grammatical analyses of the texts of the documents or indeed analyses of any images present in the documents.

In the case of classifications of the topics covered, the classifications may be arranged in nomenclatures, i.e. closed lists of possible topics, using standardized terms to describe them; it is therefore then possible to exactly compare the topics covered by such and such a document with the topics covered by other documents. In the case of comparison of the exact topics covered by a number of documents, the list obtained by a conventional document search will be reorganized in order to bring to the front documents that will be the most useful to the user.

In one embodiment, which may be implemented alternatively to or cumulatively with the preceding embodiments, the method comprises:

associating with at least one document of the set of documents at least one datum representative of concepts present in said document.

Thanks to this embodiment, an association is created between the documents and the concepts that are present in each document. This association makes it easy to manipulate the documents and concepts present in the documents.

In one embodiment, which may be implemented alternatively to or cumulatively with the preceding embodiments, the associating step comprises grouping a plurality of documents when the same concept is present in said plurality of documents.

Thanks to this embodiment, the explicit association of a datum representative of a concept with a document in which the concept is present may be avoided. Rather than making an explicit association, documents containing identical or similar concepts will be grouped together, in order to subsequently take into account the fact that they cover identical concepts. Concepts may be deemed identical or similar when their representative data are identical (for example if it is a question of classifications) or sufficiently close according to a distance that takes into account the notion of semantic proximity (for example, in the case of embeddings, the cosine similarity between vectors).

In one embodiment, the classifications are not defined beforehand. In this embodiment, the semantic analysis of the documents itself will extract the topics and list them in a unified way, associated with the analyzed documents. In one embodiment, the semantic analysis uses a previously defined classification and supplements it with new topics revealed by the semantic analysis. Here, an initial classification serves as a starting point for classifying the documents in question, but this classification is not set in stone. The semantic analysis may discover covered topics absent from the initial classification and enrich it by adding the discovered topic to the initial classification, in a manner consistent with the hierarchy of the topics contained in the classification.

In another embodiment, technical characteristics are associated with the documents. These technical characteristics include the nature of the documents to indicate whether they are texts, or images, video, audio documents, or multimedia documents having more than one technical nature. These technical characteristics make it possible to adapt the semantic analysis tools to the various natures of documents to be covered. For example, the method will use image analysis tools to extract concepts present in the images forming part of the document, while textual analysis tools will be used for the texts of the document.

In one embodiment, the step of associating with at least one document data representative of the concepts present in said document is carried out prior to the implementation of the method. For example, the step of associating concepts with documents may be carried out simultaneously with the step of indexing documents, which is carried out regularly by search engines.

In another embodiment, the step of associating data representative of concepts present in the documents is carried out for the documents belonging to the first list of documents, which list is obtained via an index search query. If the documents returned by the search query have not been analyzed beforehand and therefore have not been searched for the concepts present, this associating step may be carried out at the time of the search.

The step of obtaining a first list of documents corresponds to a conventional search for documents based on a search query, using the indexation of the documents by the terms of the query. Documents indexed by the terms of the query will be added to this first list.

According to one embodiment, which may be implemented alternatively to or cumulatively with the preceding embodiments, the second step of obtaining a second list takes into account those concepts associated with the documents of the first list that are attached to terms of the search query made in the first obtaining step.

Thanks to this embodiment, the second step of obtaining a second list of documents is improved. The terms of the query used in the first obtaining step make it possible to obtain a first list of documents. Concepts are associated with these documents; and in particular, specific concepts are associated with the specific terms of the search query. Specifically, semantic analysis techniques are able to preserve information on the location in the document where the associated concept was found. The second step of obtaining a second list will then use these specific concepts, attached to the terms of the user's query, because these concepts correspond to the semantics of the search conducted by the user as expressed in the documents found by the index search query.

According to one embodiment, which may be implemented alternatively to or cumulatively with the preceding embodiments, the data representative of concepts present in the documents are data among the following:

hierarchical lists containing sub-concepts included in concepts;

data identifying unique items covered by the documents.

Thanks to this embodiment, the association of the documents with the topics covered is improved. Specifically, the embodiment makes it possible to refine the discovery and use of the concepts and topics covered by the documents by organizing them hierarchically. It is thus possible to know in more detail the topics covered by the searched documents.

It is also possible in some cases to identify specific topics covered by the documents, which may then be exploited. In some cases, for example in the case of a database of classified advertisements, a document covers one specific item. The semantic analysis tools may identify that various documents in fact cover the same item. In the case of classified advertisements, for example, image analysis tools may perform analyses of the photographs of illustrations to detect that different advertisements are in fact about the same item. These analyses may be confirmed by the identity of the generic characteristics present in the advertisement, such as the category of the item, price etc. It is then useful to associate with the various documents covering the same item an identifier of this item. The identifier chosen to identify the item may be randomly generated by the method.

According to one embodiment, which may be implemented alternatively to or cumulatively with the preceding embodiments, the association with a document of representative data comprises:

chaptering the document, the data representative of concepts being associated with the various chapters identified in the document depending on where the concepts are located in the document.

Thanks to this embodiment, the association of the documents with the topics covered is further improved. Specifically, attaching topics or sub-topics to specific chapters of documents makes it possible to better describe the coverage of the topics by the analyzed documents. This information will allow users to better weight the how well the documents meet their search criteria. Technical classifications of document types may also be used here to indicate whether a document contains text, divided into various paragraphs, but also photos, is an audio document, a video, etc.

According to one embodiment, which may be implemented alternatively to or cumulatively with the preceding embodiments, the method comprises:

obtaining a first list of documents among the set, the first list being the result of an index search query.

According to one embodiment, which may be implemented alternatively to or cumulatively with the preceding embodiment, obtaining a second list of documents takes into account those concepts associated with the documents of the first list that are attached to terms of the search query made during the obtainment the first list.

These embodiments make it possible to combine the conventional results of an index search, which makes it possible to obtain the first list of documents, with the use of concepts present in the documents that will improve this first search. In particular, taking into account concepts associated with the terms of the index search query makes it possible to broaden this query to concepts that may have a number of synonyms, not necessarily present in the query.

According to one embodiment, which may be implemented alternatively to or cumulatively with the preceding embodiment, the associating step comprises chaptering the documents and the second obtaining step takes into account only the concepts present in the chapters in which are found terms of the search query used in the first obtaining step.

Thanks to this embodiment, the second step of obtaining a list is carried out using concepts that are as meant by the user since this second obtaining step is carried out using the concepts present in chapters in which are found the terms of the query used in the first obtaining step.

In one embodiment, the chaptering takes into account parts of documents that are references or links to other documents. In one embodiment, concepts associated with the documents pointed to by these links are also associated with the document containing the link.

According to one embodiment, which may be implemented alternatively to or cumulatively with the preceding embodiments, the first list of documents obtained as the result of an index search query is a list ordered according to a relevance score given to the documents by the index search algorithm.

Thanks to this embodiment, users of the method according to an aspect of the present disclosure benefit from the advantages of a conventional document search. The relevance of the documents in relation to an index search is evaluated for example by the number of keywords present in the document or by notions concerning page popularity. Elements used to order the results of the document search remain relevant to the method according to an aspect of the present disclosure and may be used therein.

In one embodiment, the user who provided the terms of the index search query indicates the relevant parts of the lists obtained by either of the first and second obtaining steps. These relevant parts may correspond to various chapterings of the documents. In this way, the relevance of the results is improved by direct feedback from the user, allowing their query to be better understood.

According to one embodiment, which may be implemented alternatively to or cumulatively with the previous embodiments, the obtainment of the second list of documents comprises one or more of the following steps:

adding to the first list of documents among the set the associated concepts of which correspond to those of documents already present in the first list;

removing a document when the concepts associated with the document correspond to those associated with another document;

relating a first document to a second document depending on concepts associated with the second document that are complementary to concepts of the first document;

the user of the method consulting the relevance of the documents of the list;

the user of the method indicating the relevance of the documents of the list.

Thanks to this embodiment, the results of an index search query are improved using one or more possible optimizations.

The addition of documents that were not suggested by the first search, or that were suggested with a low level of visibility, but that cover the same topics as documents obtained in the first list with a high level of visibility, allows the first search to be supplemented using the concepts present in the documents. In this way, the method according to an aspect of the present disclosure makes it possible to guarantee that every document covering a given topic will be clearly visible to a user of the method according to an aspect of the present disclosure.

Symmetrically, this embodiment of the method effectively removes duplicate documents from the results of a search. When a plurality of documents cover the same topics, only one among these various documents will be kept. Documents that cover a subset of the topics of a more comprehensive document will thus be removed. Should topics be covered equally, only one document will be kept, for example the one that was ranked highest in the step of obtaining an ordered list of documents, which corresponds to a conventional search using indexed terms. This embodiment therefore makes it possible to greatly improve the results of the search for documents by keeping only a single document associated with a specific list of covered topics.

Moreover it is possible, thanks to a step employed here, to place a first document opposite a second document depending on the concepts present in the documents, i.e. the topics covered by the respective documents. Documents are so placed in relationship if the topics covered by the second document are complementary to those covered by the first document. For example, the documents in question may be financial announcements, one of the topics covered by the first document possibly being the turnover of a company for the current year and one of the topics covered by the second document possibly being the market prospects of the same company for the following year. The second document covers a complementary topic or a sub- topic of the topic present in the first document and placing the second document in relationship with the first in the results list will allow the result of the user's search to be improved. For example, if the topic covered is the financial results in the 3rd quarter of 2024 of a given company, possible sub-topics will be the various turnovers in various geographical regions or for various subsidiaries of the company in question. Possible complementary topics will be the outlook for the whole of 2024, the change in the stock market valuation of the company following the results, the appointment of a company manager, a comparison with other companies in the same sector, etc.

Lastly, an aspect of the present disclosure refines the search results by highlighting documents that have not yet been consulted by the user. It is also possible to locate concepts associated with documents deemed relevant by the user and to suggest other documents containing the same concepts. In this way, the documents that are most relevant to the user are suggested.

According to one embodiment, the method comprises:

grouping documents associated with the same concepts in the same group, a document being selected from said same group according to the relevance of the documents of the first list resulting from the index search.

By virtue of this embodiment, the method avoids suggesting too many documents. It allows users wishing to do so to make a notable saving in terms of browsing time, by saving them the need to consult documents that are no different semantically. For a specifically covered topic, as identified by a concept associated with a plurality of documents, these documents are grouped together but only one of them will be selected and will be put forward as a representative example of all the documents in the group. For example, the selected document will be the one that had the greatest relevance in the first searching step. The other documents in the group will be accessible to the user, but in a way that is less visible.

According to a first hardware aspect, the present disclosure relates to a search manager for managing the search for documents among a set of documents, the documents being indexed, the search manager comprising:

a second search engine capable of obtaining a second list of documents from a first list of documents by taking into account a concept present in a document of the first list, the documents of the first list resulting from an index search among the set of documents.

According to one embodiment of this hardware aspect, the search manager comprises:

a coupler capable of associating with at least one document of the set one or more data representative of concepts present in said document.

According to one embodiment, which may be implemented alternatively to or cumulatively with the preceding embodiment, the search manager comprises:

a first search engine capable of obtaining a first list of documents among the set, the first list being the result of an index search query.

According to another hardware aspect, the present disclosure relates to a computer program capable of being implemented by a management entity, the program comprising code instructions which, when the program is executed by a processor, carry out the steps of the method for managing the search for documents that was defined above.

According to another hardware aspect, the present disclosure relates to a data medium on which there is recorded a computer program comprising sequences of instructions for implementing the method for managing the search for documents that was defined above.

The data media may be any entity or device capable of storing the programs. For example, the media may comprise a storage means, such as a ROM, for example, a CD-ROM or a microelectronic circuit ROM, or even a magnetic storage means, such as a hard disk. Moreover, the media may be transmissible media such as an electrical or optical signal, which may be routed via an electrical or optical cable, by radio or by other means. The programs according to an aspect of the present disclosure may, in particular, be downloaded from the Internet. As an alternative, the information medium may be an integrated circuit in which the program is incorporated, the circuit being designed to perform or be used for performing the method in question. The program according to an aspect of the present disclosure may use any type of digital technology in terms of compiled or interpreted programming languages or a combination of the two, as well as in terms of operating systems.

### BRIEF DESCRIPTION OF THE FIGURES

One or more aspects of the present disclosure will be better understood on reading the following description, which is given by way of example and with reference to the appended drawings, in which:

FIG. 1 shows a search manager implementing the method according to the disclosure.

FIG. 2 illustrates one example of steps implemented in the context of one embodiment of the disclosure.

### DETAILED DESCRIPTION

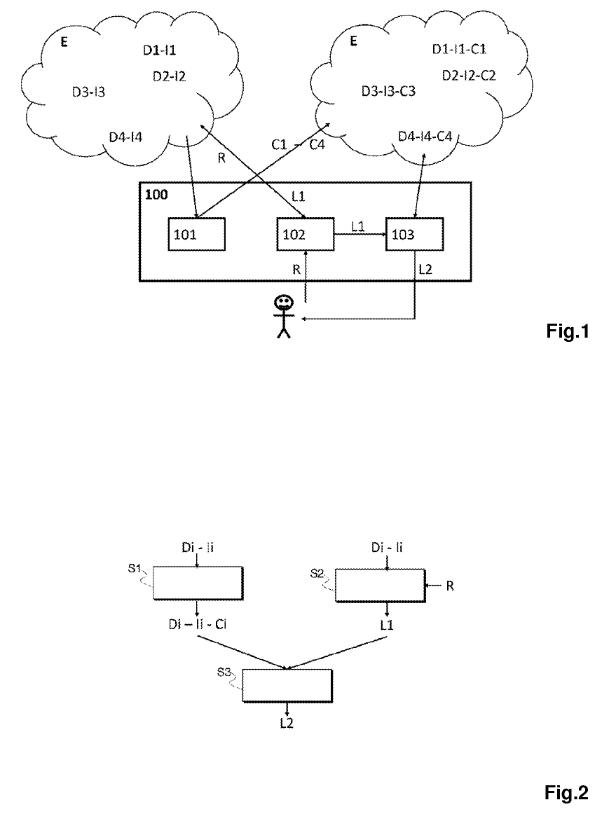

FIG. 1 shows a search manager 100 implementing a method for managing the search for documents among a set E of documents according to one exemplary embodiment.

The set E of documents may, for example, be a set of documents accessible on the Internet or indeed be a smaller set of documents such as a set of classified advertisements or a set of news agency reports. The documents D1 to D4 of the set E are indexed, i.e. they are associated with indexes I1 to I4 containing possible search terms present in the documents. Thanks to the indexation, which is carried out prior to the implementation of an aspect of the present disclosure and does not form part thereof, it is possible to easily answer the question of whether a term is present in a given document.

The management entity 100 comprises, in this exemplary embodiment:

A coupler 101 capable of associating with the documents D1 to D4 of the set E data representative C1 to C4 of concepts present in the documents;

A first search engine 102 capable of obtaining a first list L1 of documents among the set E;

A second search engine 103 capable of obtaining a second list L2 of documents from the first list L1 by taking into account a concept (C1 to C4) present in a document of the first list (L1).

In other exemplary embodiments, the management entity 100 comprises only the second search engine 103 and the functionalities performed by the coupler 101 and the first search engine 102 may be performed by entities external to the search manager 100.

The search manager 100 has the hardware architecture of a conventional computer. It in particular comprises a processor, a random-access memory (RAM), a read-only memory (ROM) such as flash memory (not shown in the figure), input/output devices such as, in some cases, keyboards and/or screens (not shown in the figure), and network ports allowing communication with other entities and servers through a communication network such as the Internet (not shown in the figure). The manager 100 may be a server implementing a document search method. The manager 100 may also be a mobile terminal implementing the same document search method. The manager 100 may be a desktop or laptop computer implementing the method of an aspect of the present disclosure. The manager 100 may also be deployed in a cloud architecture and not be attached to hardware resources that are set once and for all but in contrast run on demand on various hardware resources, depending on the availability of the cloud architecture.

The coupler 101 implements the step of associating with the documents D1 to D4 data C1 to C4 representative of concepts present in the respective documents, which is present in certain embodiments of the method. It will sometimes be stated, more directly, that C1 to C4 are concepts present in documents D1 to D4 that correspond to topics covered by these respective documents. In the example of FIG. 1, a single datum is associated with each document, but this is by no means the general case. The method will generally associate a plurality of data, and therefore concepts, with each document of the set E. In other embodiments, the association may be carried out by an entity external to the search manager 100 or indeed the concepts present in the documents may be searched for on the fly without necessarily being associated with the documents.

A datum representative of a concept present in a document is obtained by various means implemented by the coupler 101, and in particular semantic analysis means derived from artificial intelligence. These means make it possible to perform a semantic analysis of the documents of set E in order to extract the various concepts present and topics covered by the documents.

A datum representative of a concept may take a number of forms depending on the semantic analysis means employed. In a first example, the concepts are represented by instances of classifications describing the topics covered hierarchically. Such instances will, for example, be character strings or any other suitable digital object. Such a classification may be given beforehand, or discovered by tools for analyzing the documents of the set E. A classification may exist beforehand and give a general structure to the documents present in the set E: this will be the case, for example, when the set E is small (site of classified advertisements, news agency reports, sports results, etc.). This prior classification may then be refined by semantic analysis tools which discover new concepts in the documents, attached to broader topics present in the prior classification.

Another example of data representative of concepts are elements described in a semantic representation language such as AMR or OWL or RDFS (abbreviation of Resource Description Framework Schema). Such languages are dedicated to the representation of concepts that may be organized into ontologies. The elements described in these languages are embodied in digital objects such as XML files or character strings.

Another example of data representative of concepts are embeddings, i.e. vectors of real numbers. Such semantic data correspond to the results of training coefficients of artificial neural networks. These vectors are large in size, namely several hundred real numbers. Their digital representation will for example use data types allowing real numbers to be represented, such as elements in the float 32 format (real numbers encoded on 32 bits).

Depending on the representative data used, various means make it possible to decide whether two different representative data correspond to the same concept. When these data are digital objects such as character strings or instances of a language, the way in which a decision is made may regard the equality of the digital objects in question. Synonymous terms may be considered identical; a thesaurus being used to identify the underlying concepts. In the case of digital representative data, such as embeddings, a notion of a suitable distance may be defined, in order to make it possible to decide that representative data that are distinct but separated by a distance smaller than a given threshold represent the same concept. Such a suitable distance may be the cosine similarity, but other distances may be chosen.

The semantic analysis means are first and foremost textual analysis means. Such means will first perform a syntactic analysis of the text of the document with a view to extracting various sentences therefrom. Grammatical and vocabulary-based analyses then make it possible to extract the various concepts expressed in the textual parts of the document and in particular the topics covered. The semantic analysis means allow the concepts present in the document to be linked to specific parts of the document.

The semantic analysis means may also be image analysis means. In the analysis of documents such as classified advertisements, image analysis may make it possible to identify that documents using different textual presentations in fact concern the same item.

Some semantic analysis means chapter documents, i.e. they divide them into consistent parts, for example the various paragraphs of the text, but also sub-paragraphs if a given paragraph mentions more than one unrelated concept. The concepts associated with the documents may therefore, in embodiments, be associated with specific parts of the analyzed documents.

The concepts associated with the various documents may be stored in a suitable data structure, so as to permanently keep information on this association in memory. However, it is possible not to record the data representative of concepts associated with the documents of the set E. The associated concepts may merely be used to group documents in the set E and to determine whether they are alike. In this case, it is not necessary to explicitly record which are the data representative of concepts associated with the documents.

The first search engine 102 carries out a search for documents among the documents of the set E according to the terms of a query R made by a user. The terms present in the documents D1 to D4 of the set E will have been indexed beforehand, this ensuring a rapid execution of the search by the engine 102. The search thus carried out uses prior-art search techniques to obtain a list L1 of documents answering the query. Depending on the search algorithms used, the list L1 may or may not be ordered. Relevance scores may or may not be assigned to the various documents of the list L1.

In exemplary embodiments, the first search engine 102 is external to the search manager 100.

The second search engine 103 will obtain a second list L2 of documents that is more relevant to the user's search, starting with the list L1 obtained by the engine 102 and by taking into account the concepts present in the documents of the set E. To use a linguistic terminology, while the existing techniques for searching for documents by indexed terms stop at the signifier, the method according to an aspect of the present disclosure uses the significance of the document, the concepts present in it, to improve the search.

A number of improvements may be implemented by the engine 103 when producing the list L2 from the list L1.

The first improvement will consist in supplementing the documents of the list L1 with other documents that were not retrieved by the search conducted by the first engine 102. These supplementary documents are documents that cover the same topics, but that do so using terms absent from the search. In this way, the method makes it possible to find the documents of the set E that cover a given topic, even if the user used in their query terms that are absent from the documents in question. In examples, the list L2 of documents explicitly displays the concepts associated with the documents so that the user may see the concepts found by the method in the documents retrieved following the search R the terms of which were provided by the user.

It is also possible to chapter the documents of the first list L1. The second obtaining step takes into account only the concepts present in chapters in which the terms of the search query used in the first obtaining step are found. In this way, the method ensures that the associated concepts are indeed those that the user had in mind when they carried out their search. A concept that is included in another concept, when these may be organized hierarchically, as is the case for classifications, may be taken into account in the documents of the list L2, even if the parent concept itself is not present in a document of the list L2.

The presentation of the L2 list may highlight the order of the concepts present in the documents, and their hierarchical organization, when the documents of the list L2 are displayed to the user.

Another example of improvement is the removal of duplicate documents from the list L1. Documents that contain identical concepts with simple differences in form may be detected in the list L1 by comparing the concepts that have been associated with the documents by the coupler 101.

The various possible improvements making it possible to obtain the list L2 of documents may take into account relevance scores returned by the searching step conducted by the first engine 102 and which makes it possible to obtain the first list L1.

FIG. 2, for its part, illustrates one example of steps implemented in the context of one embodiment of the disclosure.

This example is given in the context of an application of the method to improvement of the search for documents in a set E that is a site of a news agency.

The first step S1 is implemented by the coupler 101 of the management entity 100. In this example, the data representative of concepts found in the documents D1 are classifications C1 associated in this step by the coupler 101 with the various documents D1 of the set E. These documents are already indexed, i.e. associated with indexes I1 that comprises the terms present in the documents D1. The classifications C1 will in this example be categorizations of news agency reports, for example "economy", "politics", etc. A prior classification will be refined by analyzing the content of the documents. For example, the broad category "economy" could be subdivided into "company results" or "statistics", which could itself be subdivided into "GDP figures", "unemployment figures" with indications for various countries, for various dates, etc.

The second step S2 is implemented by the first search engine 102. It is a question of a search for the terms of a query. The documents the indexes Ii of which contain the terms will therefore be retrieved by the search, allowing the list L1 to be obtained. This search uses known methods. One example of a user's query could for example be "GDP France 2024". Documents containing the terms in question will then be present in the list L1.

As shown in FIG. 2, the order of steps S1 and S2 is not immutable. In exemplary embodiments, the set of documents D1 of the set E are analyzed and associated with classifications C1 as they are integrated into the set E. Step S1 is in this example carried out prior to the implementation of the method. In another example, step S1 may be carried out after step S2 so as to only analyze documents listed in the list L1.

The third step S3 corresponds to improvement of the results of the search carried out in S2 by taking into account the concepts found in and associated with the documents Di in step S1. The documents listed in the list L1 in response to the user's query "GDP France 2024" will certainly include documents associated with the classifications "economy"/ "statistics"/ "GDP figures" / "France". In examples of implementation of step S3, only one of these documents may be chosen. Depending on the user's preferences, the documents chosen by step S3 may be more complete documents, which in addition contain statistics for other dates, in order to allow comparisons with other times, or for other countries, in order allow comparisons with other countries. Concepts explaining the statistics may also be associated with other documents that are determined in step S3 to be alike. Lastly, the method according to an aspect of the present disclosure makes it possible at the same time to select a single document among a plurality when the concepts are identical, in order to avoid repetitions of documents in the list L2, and to select documents containing concepts complementary to those associated with the initial query in order to supplement the list L1 with new documents in the list L2.

Finally, it will be noted here that, in the present text, each of the various components of the search manager (coupler and search engine ) may either be a software component or a hardware component or an assembly of software and hardware components, a software component itself being one or more computer programs or sub-routines or, more generally, any element of a program that is able to implement a function or a set of functions such as described for the component in question. Similarly, a hardware component is any element of a hardware assembly (or piece of hardware) that is able to implement a function or a set of functions for the component in question (integrated circuit, chip card, memory card, etc.).

What is claimed is:

1. A method for managing a search for documents among a set of documents, the documents being indexed, the method being implemented by a search manager device and comprising:obtaining a second list of documents from a first list of documents by taking into account a concept present in a document of the first list, the documents of the first list resulting from an index search among the set of documents.

2. The method for managing the search for documents as claimed in claim 1, wherein obtaining the second list of documents depends on at least one datum representative of at least one concept present in the documents of the first list.

3. The method for managing the search for documents as claimed in claim 2, wherein the method comprises:associating with at least one document of the set at least one datum representative of at least one concept present in said at least one document of the set.

4. The method for managing the search for documents as claimed in claim 3, wherein the association comprises grouping a plurality of documents when a same concept is present in said plurality of documents.

5. The method for managing the search for documents as claimed in claim 2, wherein the at least one datum representative of at least one concept present in the documents are data among the following:hierarchical lists containing sub-concepts included in concepts;data identifying unique items covered by the documents.

6. The method for managing the search for documents as claimed in claim 3, wherein the association with a document of representative data comprises:chaptering the document, the data representative of concepts being associated with various chapters identified in the document depending on where the concepts are located in the document.

7. The method for managing the search for documents as claimed in claim 1, wherein the method comprises:obtaining the first list of documents among the set, the first list being a result of an index search query.

8. The method for managing the search for documents as claimed in claim 7, wherein obtaining the second list of documents takes into account those concepts associated with the documents of the first list that are attached to terms of the search query made during the obtaining of the first list.

9. The method for managing the search for documents as claimed in claim 7, wherein the association comprises chaptering the documents and obtaining the second list of documents takes into account only the concepts present in the chapters in which are found terms of the search query used in obtaining the first list of documents.

10. The method for managing the search for documents as claimed in claim 1, wherein obtaining the second list of documents comprises one or more of the following steps:adding to the first list of documents other documents selected among the set of documents, the associated concepts of those other documents corresponding to those of documents already present in the first list;removing a document when the concepts associated with the document correspond to those associated with another document;
relating a first document to a second document depending on concepts associated with the second document that are complementary to concepts of the first document;
a user of the method consulting a relevance of the documents of the first list;
a user of the method indicating the relevance of the documents of the first list.

11. The method for managing the search for documents as claimed in claim 1, wherein obtaining the second list of documents comprises:grouping documents associated with same concepts in a same group, a document being selected from said same group according to relevance of the documents of the first list resulting from the index search.

12. A search manager device comprising:at least one processor; andat least one non-transitory computer readable medium comprising instructions stored thereon which when executed by the at least one processor configure the search manager device to manage a search for documents among a set of documents, the documents being indexed, by:
implementing a second search engine to obtain a second list of documents from a first list of documents by taking into account a concept present in a document of the
first list, the documents of the first list resulting from an index search among the set (E) of documents.

13. The search manager as claimed in claim 12, wherein the instructions further configure the search manager device to implement a coupler to associate with at least one document of the set one or more data representative of concepts present in said document.

14. The search manager as claimed in claim 12, wherein the instructions further configure the search manager device to implement a first search engine to obtain the first list of documents among the set, the first list being a result of an index search query.

15. A non-transitory computer readable data medium on which there is recorded a computer program comprising sequences of instructions for implementing the method for managing the search for documents as claimed in claim 1.
